(19) United States
(12) Patent Application Publication
(10) Pub. No.: US 2025/0356639 A1
(43) Pub. Date: Nov. 20, 2025

(54) OBJECT RECOGNITION SYSTEM, OBJECT RECOGNITION METHOD, AND RECORDING MEDIUM

(71) Applicant: NEC CORPORATION, Minato-ku, Tokyo (JP)

(72) Inventor: Hiroshi YOSHIDA, Tokyo (JP)

(73) Assignee: NEC CORPORATION, Minato-ku, Tokyo (JP)

(21) Appl. No.: 18/873,376

(22) PCT Filed: Jul. 14, 2022
(86) PCT No.: PCT/JP2022/027662

§ 371 Date: Dec. 10, 2024

(51) Int. Cl. G06V 10/776; G06V 10/772; G06V 10/94

(52) U.S. Cl. CPC G06V 10/776; G06V 10/772; G06V 10/95

(57) ABSTRACT

An object recognition system according to an aspect of the present disclosure includes: at least one memory configured to storing instructions; and at least one processor configured to execute the instructions to: execute an object recognition of a moving object appearing in a camera using a recognition dictionary; acquire a first index value indicating reliability of a result of object recognition of the moving object; acquire a second index value representing an imaging environment of the camera; determine whether it is required to change a recognition dictionary to be used for the object recognition based on the first index value; and select the recognition dictionary to be used for the object recognition from among a plurality of recognition dictionaries based on the second index value when it is determined that the recognition dictionary is to be changed.

### TECHNICAL FIELD

The present invention relates to an object recognition system, an object recognition method, and a recording medium.

### BACKGROUND ART

PTL 1 discloses a video processing device capable of recognizing a highly reliable video even when a recognition environment that affects recognition accuracy of a video captured by an imaging device changes. According to PTL 1, this video processing device includes a recognition environment acquisition unit that acquires a recognition environment factor at the time of imaging that affects recognition accuracy of a video captured by an imaging device, a recognition accuracy calculation unit that calculates the recognition accuracy due to the recognition environment factor acquired by the recognition environment acquisition unit with reference to the recognition environment factor that stores the recognition environment condition that is a correspondence between the recognition accuracy of the video and the recognition environment factor, and a recognition reliability calculation unit that calculates the recognition reliability from the calculated recognition accuracy. Furthermore, PTL 1 describes that, in a case where, for the same recognition target, a result of alarm activation by another video processing device is different from that by the host video processing device, the host video processing device determines that there is an abnormality in the recognition result by the video processing device, and presents a proposal for improvement of a function of outputting the recognition result such as a change in an algorithm (paragraph 0057 and the like).

### CITATION LIST

### Patent Literature

PTL 1: JP 2021-39687 A

### SUMMARY OF INVENTION

### Technical Problem

As a problem common to object recognition systems installed outdoors, there is a problem that recognition accuracy changes depending on weather, day and night, or weather. In this regard, the video processing device of PTL 1 describes that, when it is determined that there is an abnormality in the recognition result, a proposal for improvement of a function of outputting the recognition result such as change of an algorithm is presented, but it is difficult to automatically improve the function.

An object of the present invention is to provide an object recognition system, an object recognition method, and a recording medium capable of suppressing deterioration in recognition performance due to a change in environment such as a time zone such as day and night or weather.

### Solution to Problem

According to a first aspect, provided is an object recognition system including an object recognition means for executing object recognition of a moving object appearing in a camera using a recognition dictionary, a first acquisition means for acquiring a first index value indicating reliability of a result of object recognition of the moving object, a second acquisition means for acquiring a second index value representing an imaging environment of the camera, and a control means for determining whether it is required to change a recognition dictionary to be used for the object recognition based on the first index value. When it is determined that the recognition dictionary is to be changed, the control means of the object recognition system selects, based on the second index value, a recognition dictionary to be used in the object recognition from among a plurality of recognition dictionaries.

According to a second aspect, provided is an object recognition method including executing object recognition of a moving object appearing in a camera using a recognition dictionary, acquiring a first index value indicating reliability of a result of object recognition of the moving object, determining whether it is required to change a recognition dictionary to be used for the object recognition based on the first index value, and when it is determined that the recognition dictionary is to be changed, acquiring a second index value representing an imaging environment of the camera, and selecting the recognition dictionary to be used for the object recognition from among a plurality of recognition dictionaries based on the second index value.

According to a third aspect, provided is a recording medium recording a program for causing a computer to execute executing object recognition of a moving object appearing in a camera using a recognition dictionary, acquiring a first index value indicating reliability of a result of object recognition of the moving object, determining whether it is required to change a recognition dictionary to be used for the object recognition based on the first index value, and when it is determined that the recognition dictionary is to be changed, acquiring a second index value representing an imaging environment of the camera, and selecting the recognition dictionary to be used for the object recognition from among a plurality of recognition dictionaries based on the second index value.

### Advantageous Effects of Invention

According to the present invention, an object recognition system, an object recognition method, and a recording medium capable of suppressing deterioration in recognition performance due to a change in environment such as a time zone such as day and night or weather are provided.

### BRIEF DESCRIPTION OF DRAWINGS

FIG. 1 is a diagram illustrating a configuration of an example embodiment of the present invention.

FIG. 2 is a flowchart illustrating an operation of an example embodiment of the present invention.

FIG. 3 is a diagram for describing an operation of an example embodiment of the present invention.

FIG. 4 is a functional block diagram illustrating the configuration of the object recognition system of the first example embodiment of the present invention.

FIG. 5 is a diagram illustrating an example of a recognition dictionary set held in a recognition dictionary storage means of the object recognition system of the first example embodiment of the present invention.

FIG. 6 is a flowchart illustrating the operation of the object recognition system of the first example embodiment of the present invention.

FIG. 7 is a diagram for describing the operation of the object recognition system of the first example embodiment of the present invention.

FIG. 8 is another diagram for describing the operation of the object recognition system of the first example embodiment of the present invention.

FIG. 9 is another diagram for describing the operation of the object recognition system of the first example embodiment of the present invention.

FIG. 10 is another diagram for describing the operation of the object recognition system of the first example embodiment of the present invention.

FIG. 11 is a functional block diagram illustrating the configuration of the object recognition system of the second example embodiment of the present invention.

FIG. 12 is a diagram for describing the operation of the object recognition system of the second example embodiment of the present invention.

FIG. 13 is a functional block diagram illustrating the configuration of the object recognition system of the third example embodiment of the present invention.

FIG. 14 is a flowchart illustrating the operation of the object recognition system of the third example embodiment of the present invention.

FIG. 15 is a functional block diagram illustrating the configuration of the object recognition system of the fourth example embodiment of the present invention.

FIG. 16 is a flowchart illustrating the operation of the object recognition system of the fourth example embodiment of the present invention.

FIG. 17 is a diagram for describing the operation of the object recognition system of the fourth example embodiment of the present invention.

FIG. 18 is a diagram illustrating the configuration of a computer that can function as the object recognition system of the present invention.

### EXAMPLE EMBODIMENT

First, an outline of an example embodiment of the present invention will be described with reference to the drawings. The reference numerals in the drawings attached to this outline are attached to respective elements for convenience as an example for assisting understanding, and are not intended to limit the present invention to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with equipment (including a computer) inside or outside the device via a communication interface regardless of wired or wireless. Although there are ports and interfaces at connection points of input and output of each block in the drawing, illustration thereof is omitted.

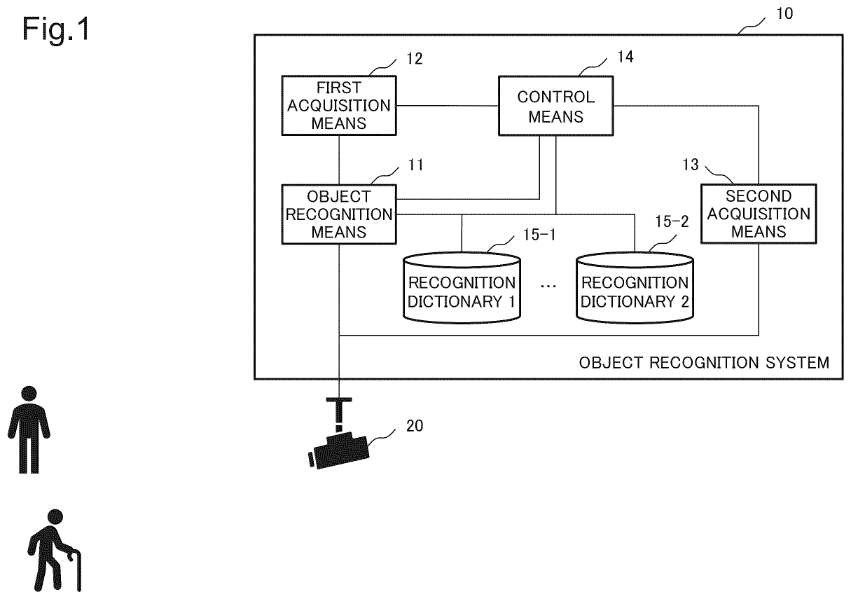

An example embodiment of the present invention, as illustrated in FIG. 1, can be achieved by an object recognition system 10 including an object recognition means 11, a first acquisition means 12, a second acquisition means 13, and a control means 14.

The object recognition means 11 executes object recognition of the moving object appearing in the camera 20 using the recognition dictionaries 15-1 to 15-2. The recognition dictionaries 15-1 to 15-2 are a set of data necessary for recognition applied to an identifier used for object recognition by the object recognition means 11, and is switched by the control means 14. For example, a plurality of types of recognition dictionaries 15-1 to 15-2 is created according to the imaging environment of the camera such as daytime, nighttime, fine weather, and rainy weather. Such a recognition dictionary can be created by preparing images obtained under different imaging environments as teacher data and using a method such as machine learning or deep learning. The identifier receives an input value to output a recognition result for the input value, and may be referred to as a learning model or an artificial intelligence (AI) model.

The first acquisition means 12 acquires a first index value indicating the reliability of the result of the object recognition of the moving object. As the first index value, mean average precision (mAP), intersection over union (IoU), or the like obtained in the process of object recognition of the moving object can be used. Of course, a value indicating the reliability of the result of the object recognition of another moving object may be calculated as the first index value.

The second acquisition means 13 acquires a second index value representing the imaging environment of the camera 20. For example, in a case where the recognition dictionary is created in the distinction between day and night, the second acquisition means 13 can obtain the second index value by acquiring the time information. In a case where the recognition dictionary is created by segments of the weather, the second acquisition means 13 may acquire weather information from an external network, sensor, or the like. For example, the second acquisition means 13 can also acquire the second index value by estimating the distinction between day and night and the weather from the image captured by the camera.

The control means 14 determines whether it is required to change the recognition dictionary to be used for the object recognition based on the first index value. In a case where it is determined that the recognition dictionary is to be changed as a result of the determination, the control means 14 selects a recognition dictionary to be used for the object recognition from among the plurality of recognition dictionaries based on the second index value, and instructs the object recognition means 11 to switch the recognition dictionary.

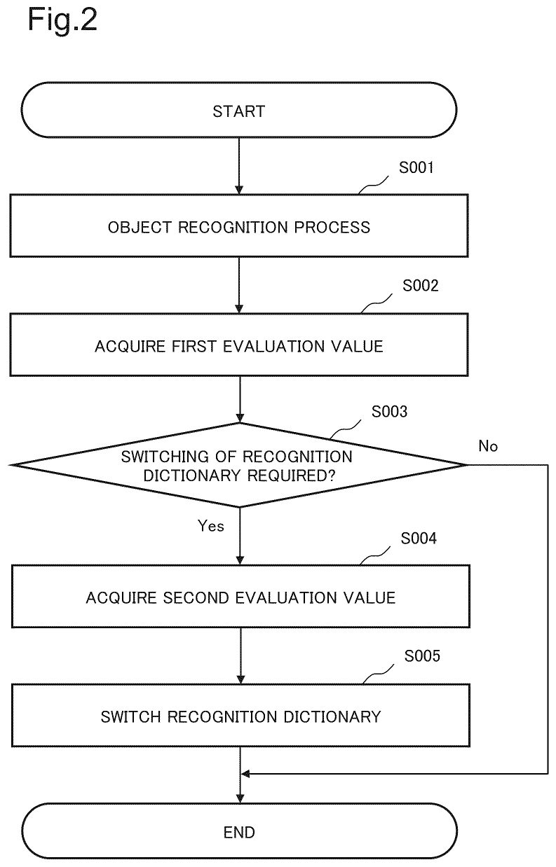

FIG. 2 illustrates an object recognition method used in the object recognition system 10 according to the present example embodiment. As illustrated in FIG. 2, the object recognition system 10 configured as described above first executes object recognition of the moving object appearing in the camera using the recognition dictionary (step S001). Next, the object recognition system 10 acquires a first index value indicating the reliability of the result of the object recognition of the moving object (step S002). Next, the object recognition system 10 determines whether it is required to change the recognition dictionary to be used for the object recognition based on the first index value (step S003).

As a result of the determination, when it is determined that the recognition dictionary is to be changed (Yes in step S003), the object recognition system 10 acquires a second index value representing the imaging environment of the camera (step S004), and selects a recognition dictionary to be used for the object recognition from among the plurality of recognition dictionaries based on the second index value and switches to the recognition dictionary (step S005). When it is determined in step S003 that the recognition dictionary is not changed (No in step S003), the object recognition system 10 omits acquisition of the second index value and change of the recognition dictionary.

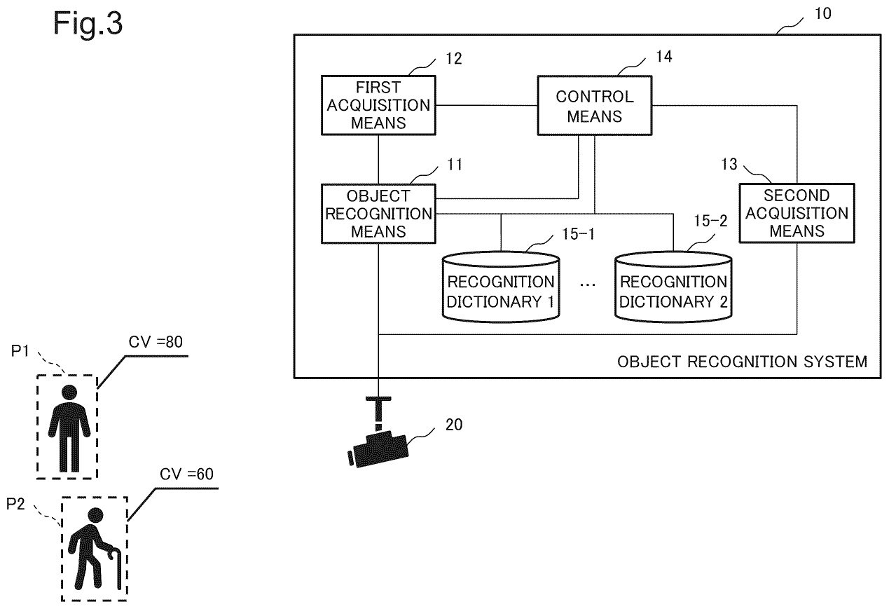

FIG. 3 is a diagram for describing an operation of an example embodiment of the present invention. For example, it is assumed that the object recognition system 10 performs object recognition using the recognition dictionary 15-1 to detect the persons P1 and P2. It is assumed that CV=80 is obtained as the first index value of the person P1 and CV=60 is obtained as the first index value of the person P2 at this time. The CV in FIG. 3 and the following is an abbreviation of Confidence Value, and it is assumed that the higher the value, the higher the reliability, with 100 as the upper limit. The object recognition system 10 determines whether it is required to change the recognition dictionary based on these first index values. For example, when it approaches sunset and the image by the camera 20 is dark, the CV decreases. The object recognition system 10 determines to change the recognition dictionary when the average CV is equal to or less than a predetermined value. The object recognition system 10 acquires time information as the second index value, and switches to a recognition dictionary for nighttime. As a result, the accuracy of subsequent object recognition is improved.

The necessity of the change of the recognition dictionary by the first index value CV can be determined using various criteria. An example thereof will be described below.
When the average CV is equal to or less than the predetermined threshold value A, the recognition dictionary is changed.
When the CV of the one or more moving objects is equal to or less than the predetermined threshold value B, the recognition dictionary is changed.
When the CV of the moving objects equal to or more than two is equal to or less than the predetermined threshold value C, the recognition dictionary is changed.
When the CV of the moving object having the specific attribute is equal to or less than the predetermined threshold value D, the recognition dictionary is changed.

According to the object recognition system 10 operating as described above, it is possible to detect a decrease in the recognition performance of the object recognition means 11 at an early stage, change the recognition dictionary, and recover the recognition performance.

### First Example Embodiment

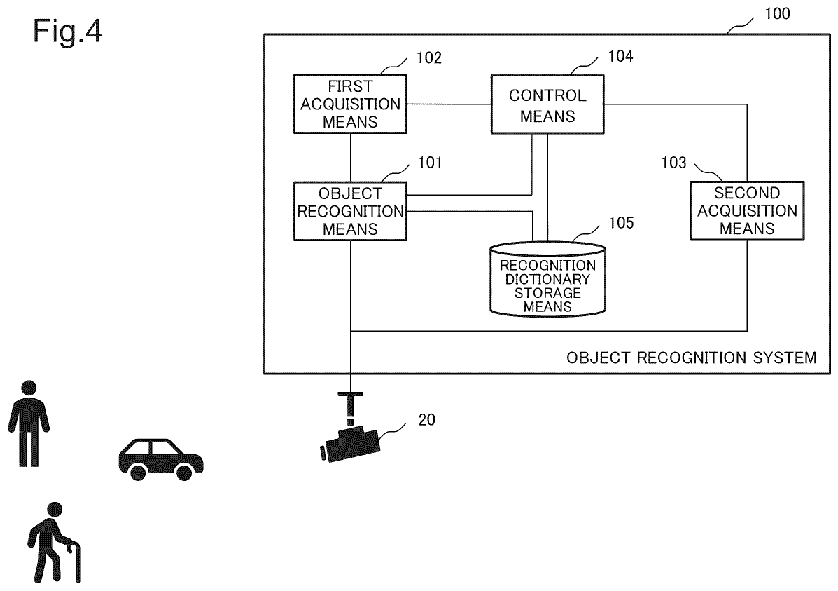

Next, a first example embodiment focused on maintaining a detection function of a moving object located in a predetermined position range will be described in detail with reference to the drawings. FIG. 4 is a diagram illustrating the configuration of an object recognition system 100 of the first example embodiment of the present invention. With reference to FIG. 4, an object recognition system 100 including an object recognition means 101, a first acquisition means 102, a second acquisition means 103, a control means 104 and a recognition dictionary storage means 105 is illustrated.

The object recognition means 101 executes object recognition of the moving object appearing in the camera 20 using the identifier to which the recognition dictionary is applied. The present example embodiment will be described assuming that the object recognition means 101 recognizes a person or a vehicle appearing in the camera to output the person or the vehicle to a predetermined output destination.

The first acquisition means 102 acquires a first index value indicating the reliability of the result of the object recognition of the moving object, and transmits the first index value to the control means 104. In the following description, the first index value is referred to as “CV”. Hereinafter, a description will be given assuming that the first acquisition means 102 acquires mAP and IoU calculated in the process of object recognition from the object recognition means 101 and calculates CV. In the present example embodiment, the upper limit of “CV” is 100, and the larger the value is, the higher the reliability of the result of the object recognition is. Of course, the first index value may be any value as long as the control means 104 can determine whether it is required to change the recognition dictionary, and it is not required to take a value of a system such as “CV” of the present example embodiment.

The second acquisition means 103 acquires a second index value representing the imaging environment of the camera 20. In the present example embodiment, a description will be given assuming that the second acquisition means 103 determines the distinction between day and night and the weather from the image by the camera 20 in response to a request from the control means 104 and returns the determination to the control means 104.

The control means 104 determines whether it is required to change the recognition dictionary used by the object recognition means 101 based on the CV received from the first acquisition means 102. As a result of the determination, when it is determined that the recognition dictionary is to be changed, the control means 104 selects a recognition dictionary from the recognition dictionary storage means 105 based on the second index value, and transmits the recognition dictionary to the object recognition means 101.

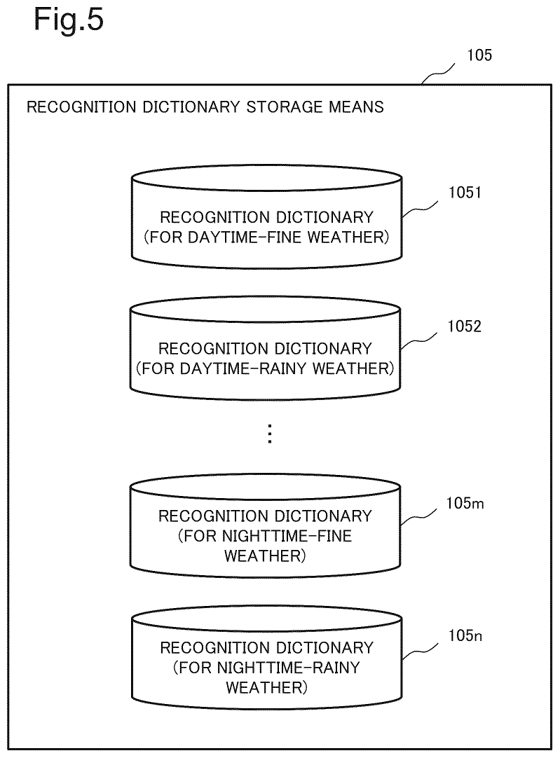

The recognition dictionary storage means 105 stores a recognition dictionary to be used for object recognition by the object recognition means 101. FIG. 5 illustrates a set of recognition dictionaries stored in the recognition dictionary storage means 105. The present example embodiment will be described assuming that the recognition dictionary storage means 105 holds recognition dictionaries that can be selected by a combination of the distinction between day and night and the weather, such as a recognition dictionary 1051 for daytime and fine weather, a recognition dictionary 1052 for daytime and rainy weather, a recognition dictionary 105m for nighttime and fine weather, and a recognition dictionary 105n for nighttime and rainy weather. In the example of FIG. 5, as recognition dictionaries, a dictionary for recognition of fine weather and a dictionary for recognition of rainy weather are prepared. Other recognition dictionaries for recognition of fog, snow, and the like may be prepared. Regarding the time, a recognition dictionary for a time zone of any length may be prepared in addition to the morning, evening, before noon, afternoon, and the like, instead of two segments of the daytime and the nighttime. Even in the same fine weather, since the position of the sun and how the shade appears are different between the morning, evening, before noon, and afternoon, the recognition accuracy may be improved by dividing the recognition dictionary. Therefore, recognition dictionaries related to combinations of time zones and weather, such as fine weather-morning, fine weather-before noon, fine weather-afternoon, fine weather-evening, and fine weather-night, may be prepared. Of course, the recognition dictionary storage means 105 may hold a recognition dictionary used in a situation other than the above situation or a further subdivided recognition dictionary.

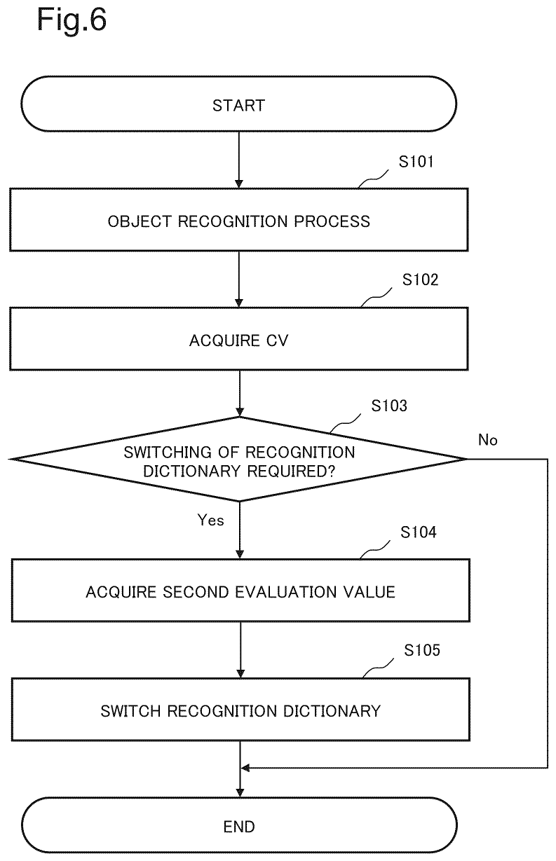

Next, the operation of the object recognition system 100 of the present example embodiment will be described in detail with reference to the drawings. FIG. 6 is a flowchart illustrating the operation of the object recognition system of the first example embodiment of the present invention. First, the object recognition system 100 executes object recognition of the moving object appearing in the camera (step S101).

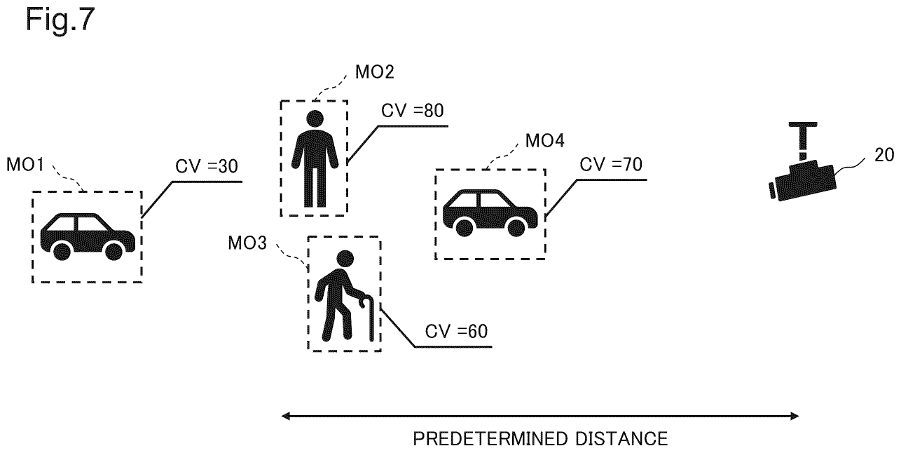

Next, the object recognition system 100 acquires the CV of the moving object detected by the object recognition (step S102). FIG. 7 illustrates an example of the moving object and its CV detected by the object recognition system 100.

Next, the object recognition system 100 determines whether it is required to change the recognition dictionary applied to the object recognition means 101 based on the CV of the moving object (step S103). At this time, the control means 104 of the object recognition system 100 selects one or more moving objects located in a predetermined distance range from the camera 20, and determines whether it is required to change the recognition dictionary using the CVs.

For example, as illustrated in FIG. 7, it is assumed that moving objects MO1 to MO4 are detected. In this case, the control means 104 of the object recognition system 100 selects the moving objects MO2 to MO4 located in a predetermined distance range from the camera 20, and determines whether it is required to change the recognition dictionary using the CVs. In the example of FIGS. 7, 80, 60, and 70 are obtained as the CV of the moving object MO2 (person), the CV of the moving object MO3 (person), and the CV of the moving object MO4 (car), respectively. For example, the control means 104 of the object recognition system 100 calculates an average CV from these CVs and compares the average CV with a predetermined threshold value to determine whether it is required to change the recognition dictionary. For example, in a case where the predetermined threshold value is 60, in the example of FIG. 7, the control means 104 of the object recognition system 100 determines that it is not required to change the recognition dictionary.

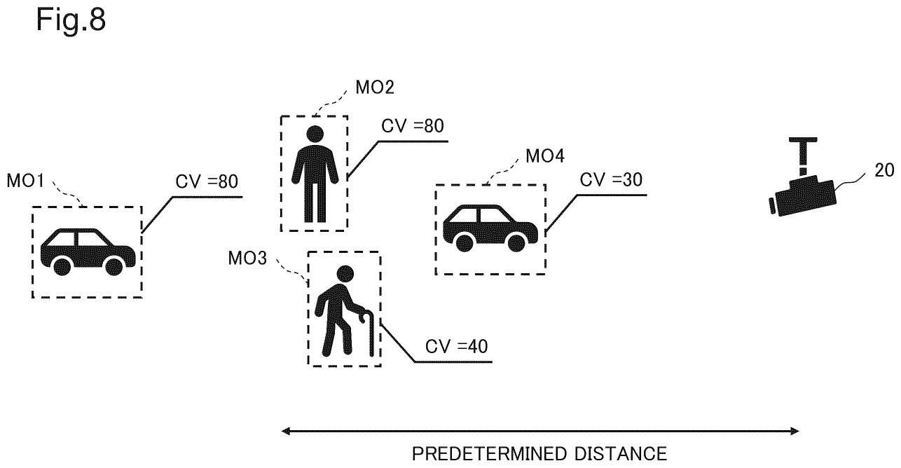

On the other hand, the recognition performance of the object recognition system 100 may deteriorate due to, for example, sunset or a change in weather. FIG. 8 is a diagram illustrating a CV in a state in which the recognition performance has deteriorated. In the example of FIGS. 8, 80, 40, and 30 are obtained as the CV of the moving object MO2 (person), the CV of the moving object MO3 (person), and the CV of the moving object MO4 (car), respectively. At this time, the average CV is 50 and when the predetermined threshold value is 60, the control means 104 of the object recognition system 100 determines that it is required to change the recognition dictionary.

In this way, when it is determined that the recognition dictionary is to be changed (Yes in step S103), the object recognition system 100 acquires the second index value representing the imaging environment of the camera (step S104), and selects a recognition dictionary to be used for the object recognition from among the plurality of recognition dictionaries based on the second index value and switches to the recognition dictionary (step S105). For example, in a case where the current situation where the camera is placed is rainy at night, the recognition dictionary for nighttime-rainy weather is selected, and the recognition dictionary is switched. As a result, the performance of the next and subsequent object recognition process is recovered.

Furthermore, as described above with reference to FIGS. 7 and 8, the object recognition system 100 of the present example embodiment selects the moving objects MO2 to MO4 located in a predetermined distance range from the camera 20, and determines whether it is required to change the recognition dictionary using the CVs. Therefore, the CV of the moving object MO4 away from the camera 20 is not used for determining whether it is required to change the recognition dictionary. In the present example embodiment, since such a moving object is selected, it is possible to grasp deterioration in recognition performance that may affect the performance of the system at an early stage and take measures.

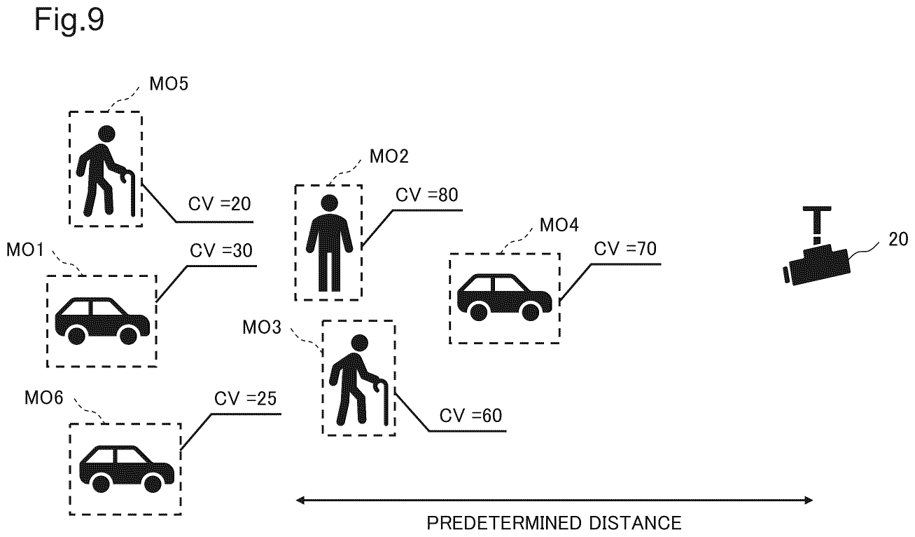

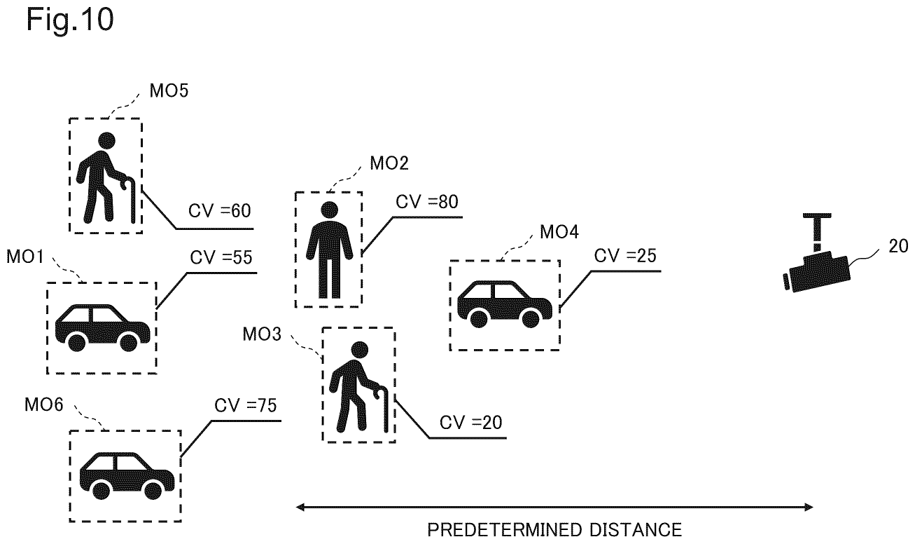

Furthermore, by selecting such a moving object, for example, as illustrated in FIG. 9, even in a case where there are a large number of moving objects outside a predetermined distance and the CVs are low, it is possible to correctly determine that it is not required to change the recognition dictionary. Conversely, even in a case where the overall CV is high as illustrated in FIG. 10, when the CVs of the moving objects within the predetermined distance are low, it can be determined that it is required to change the recognition dictionary at an early stage.

In the above description, it is described that the determination is made by comparing the average CV with the threshold value, but the method of determining whether it is required to change the recognition dictionary is not limited thereto. For example, the determination may be made using the maximum CV, the minimum CV, the intermediate value CV, or other statistical values.

### Second Example Embodiment

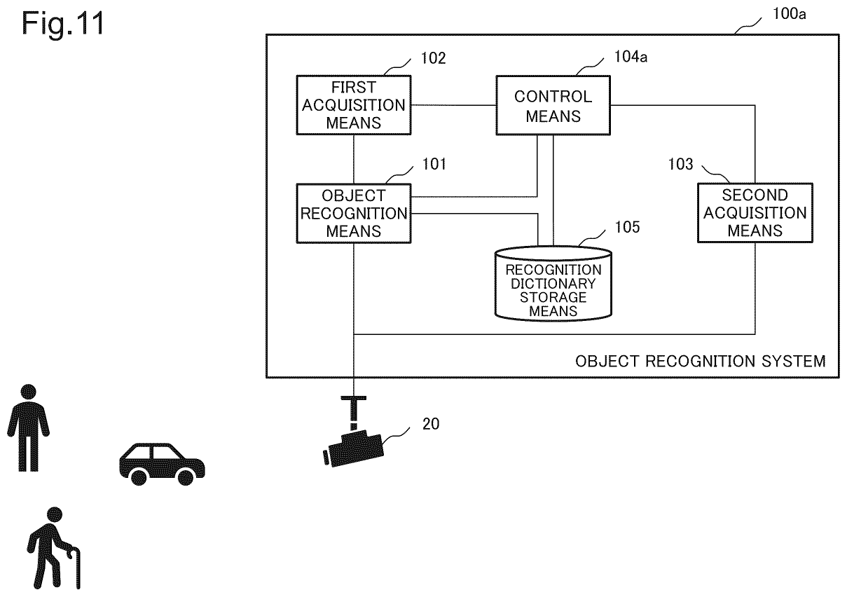

Next, the second example embodiment in which the object recognition system determines whether it is required to change the recognition dictionary in consideration of the importance of the moving object will be described. FIG. 11 is a functional block diagram illustrating the configuration of an object recognition system 100a of the second example embodiment of the present invention. A difference from the first example embodiment illustrated in FIG. 3 is the determination operation of a control means 104a as to whether it is required to change the recognition dictionary. Other configurations and operations are the same as those of the first example embodiment, and thus description thereof is omitted.

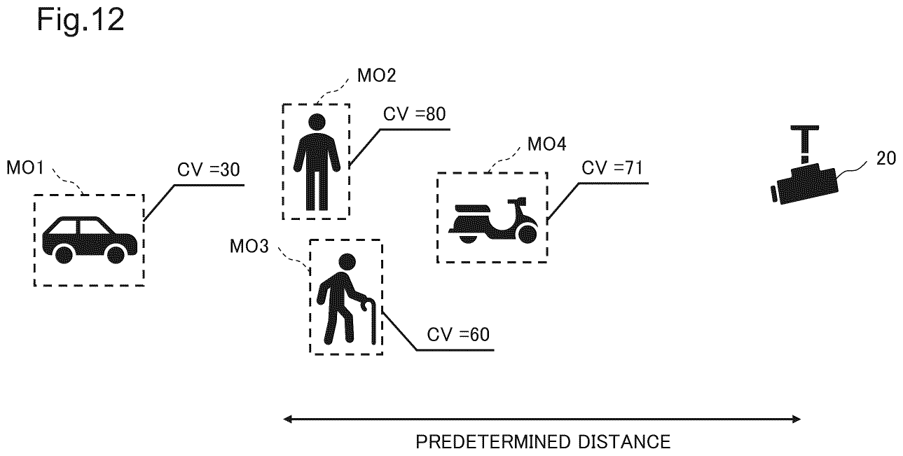

FIG. 12 is a diagram for describing the operation of the object recognition system 100a of the second example embodiment. The second example embodiment is similar to the first example embodiment in that the moving objects MO2 to MO4 are selected from the detected moving objects MO1 to MO4, and whether it is required to change the recognition dictionary is determined using the CVs. In the present example embodiment, the control means 104a of the object recognition system 100a determines whether it is required to change the recognition dictionary based on a value obtained by performing weighting for each type of the moving object.

The average value of CVs of the moving objects MO2 to MO4 in FIG. 12 is (60+80+71)/3=about 70.3. When the predetermined threshold value is 65, the control means 104a of the object recognition system 100a determines that it is not required to change the recognition dictionary. However, it is also possible to obtain the average value of the CVs of the moving objects MO2 to MO4 after multiplying the CVs of the vehicle and the pedestrian by different coefficients.

Table 1 shows CV values of a vehicle (MO4) and pedestrians (MO2, MO3).

TABLE 1

| Type | CV |
|---|---|
| Pedestrian | 60, 80 |
| Vehicle | 71 |

For example, when the coefficient to be multiplied by the CV of the pedestrian is 0.8, the coefficient to be multiplied by the CV of the vehicle is 1.0, and the average CV is obtained, the corrected average CV is ((140×0.8)+(71×1.0))/3=61. In a case where the predetermined threshold value is similarly 65, the control means 104a of the object recognition system 100a of the present example embodiment determines that it is required to change the recognition dictionary. As a result, the performance of the next and subsequent object recognition process is recovered.

The example of the weighting illustrated in FIG. 12 is merely an example. Various modifications can be made. For example, when early detection of a pedestrian is required for the use of the object recognition system 100a, a smaller value may be set as the weighting coefficient to be multiplied by the CV of the pedestrian. As a result, the average CV after the weighting correction decreases, and it is possible to prompt switching of the recognition dictionary at an early stage. In the above-described example embodiment, it is described that the type of the moving object is two types of a pedestrian and a vehicle, but the type of the moving object is not limited thereto. For example, in FIG. 12, the moving object (pedestrian) MO2 and the moving object (pedestrian) MO3 using a cane may be set as different types, and the weighted average CV may be calculated after respective CVs are multiplied by different weighting coefficients. For example, the moving object (four-wheeled vehicle) MO1 and the moving object (two-wheeled vehicle) MO4 in FIG. 12 may be set as different types, and the weighted average CV may be calculated after respective CVs are multiplied by different weighting coefficients.

As described above, according to the present example embodiment, it is possible to grasp at an early stage the occurrence of deterioration in recognition performance of a moving object of a specific type among the detected moving objects, and to prompt a change in the recognition dictionary.

In the above description, a case where the determination is made by comparing the average CV after the weighting correction with the threshold value is described, but the method of determining whether it is required to change the recognition dictionary is not limited thereto. For example, whether it is required to change the recognition dictionary may be determined using the maximum CV, the minimum CV, the intermediate value CV, other statistical values, or the like after the plurality of weighting corrections.

When it is required to change the recognition dictionary, it may be determined whether it is required to change the recognition dictionary using a method other than weighting. Specifically, the control means 104a may determine whether it is required to change the recognition dictionary based on the first index value and a reference such as a threshold value defined for each type of the moving object. For example, by setting different threshold values for the moving object (pedestrian) MO2 in FIG. 12 and the moving object (pedestrian) MO3 using a cane and performing comparison, a determination result similar to that in the above example can be obtained.

### Third Example Embodiment

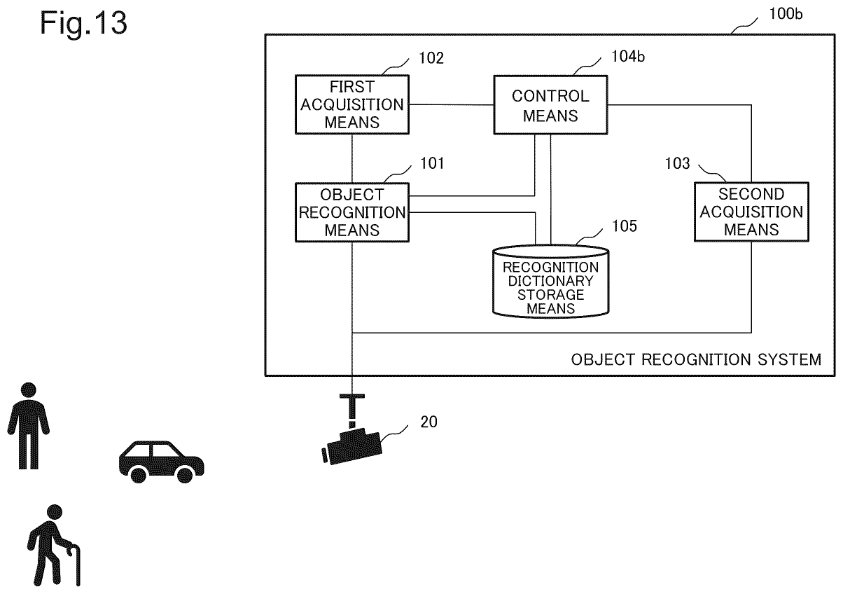

Next, the third example embodiment in which the object recognition system confirms improvement in recognition performance before switching of the recognition dictionary will be described. FIG. 13 is a functional block diagram illustrating the configuration of an object recognition system 100b of the third example embodiment of the present invention. A difference from the first example embodiment illustrated in FIG. 3 is the determination operation of a control means 104b as to whether it is required to change the recognition dictionary. Other configurations are the same as those of the first example embodiment, and thus description thereof is omitted.

In a case where it is determined that the recognition dictionary is to be changed, the control means 104b of the object recognition system 100b of the present example embodiment causes the object recognition means 101 to execute the object recognition by the recognition dictionary of the switching candidate, and confirms that the first evaluation value increases, then switches the recognition dictionary.

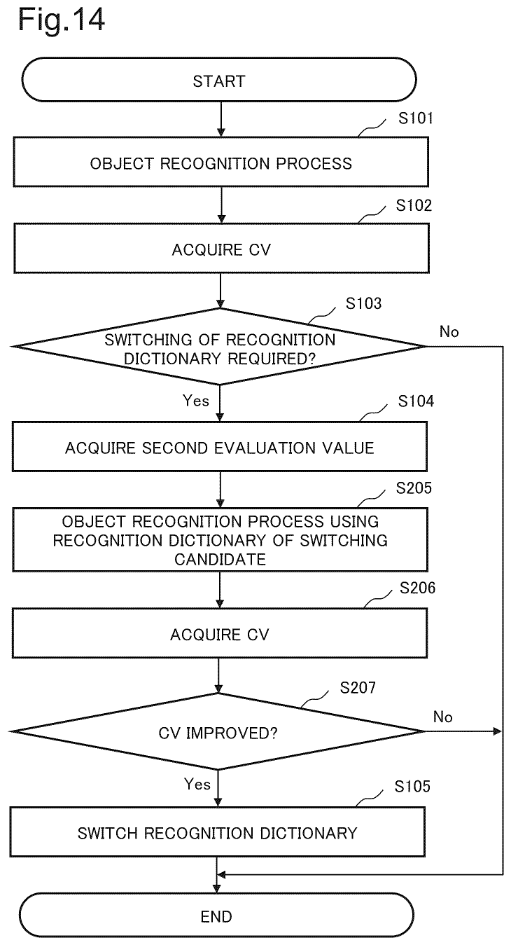

FIG. 14 is a flowchart illustrating the operation of the object recognition system of the third example embodiment of the present invention. Since the operations in steps S101 to S104 and S105 in FIG. 14 are similar to those in the first example embodiment, the differences will be mainly described below. After determining that the recognition dictionary is to be changed and acquiring the second index value representing the imaging environment of the camera, the control means 104b of the object recognition system 100b selects a switching candidate of the recognition dictionary to be used for the object recognition from among the plurality of recognition dictionaries based on the second index value. The control means 104b requests the object recognition means 101 to perform the object recognition process using the recognition dictionary of the switching candidate (step S205).

Next, the control means 104b of the object recognition system 100b requests the first acquisition means 102 to acquire the CV of the moving object detected by the object recognition to acquire the CV (step S206). The control means 104b determines whether the CV acquired in step S206 is improved (step S207). It is conceivable that the determination as to whether the CV is improved is made by comparison with the CV acquired in step S102. As another modification, determination equivalent to the determination process in step S103 may be made to determine again whether switching of the recognition dictionary is necessary. As a result of the object recognition using the candidate of the recognition dictionary, when it is determined that the switching of the recognition dictionary is not required, the candidate of the recognition dictionary is used. As a result of the object recognition using the candidate of the recognition dictionary, when it is determined that the switching of the recognition dictionary is required, it is determined that the switching to the candidate of the recognition dictionary is not required.

As a result of the determination in step S207, when it is determined that the CV has been improved, the control means 104b of the object recognition system 100b performs switching to the recognition dictionary of the switching candidate (step S105). On the other hand, as a result of the determination in step S207, when it is determined that the CV is not improved, the control means 104b of the object recognition system 100b continues to use the previous recognition dictionary (No in step S207).

As described above, according to the present example embodiment, the improvement of the CV indicating the reliability of the result of the object recognition is confirmed before the recognition dictionary is switched. Therefore, in comparison with the first example embodiment, it is possible to prevent a situation in which the accuracy of the object recognition deteriorates after the recognition dictionary is switched.

In the above description, it is confirmed that the CV is improved before the switching of the recognition dictionary. A method of calculating the CV after the switching of the recognition dictionary is performed once and returning the CV to the original recognition dictionary when the CV is low can be used.

The description of the third example embodiment described above is made assuming that whether it is required to change the recognition dictionary is confirmed using a method similar to that of the first example embodiment. The second example embodiment and the third example embodiment can be combined. In this case, it is possible to adopt a mode in which the control means 104b of the object recognition system 100b determines whether it is required to change the recognition dictionary with emphasis on the CV of the moving object of the specific type among the detected moving objects, and checks whether the CV of the moving object of the specific type has been improved in the improvement of the CV in step S207.

### Fourth Example Embodiment

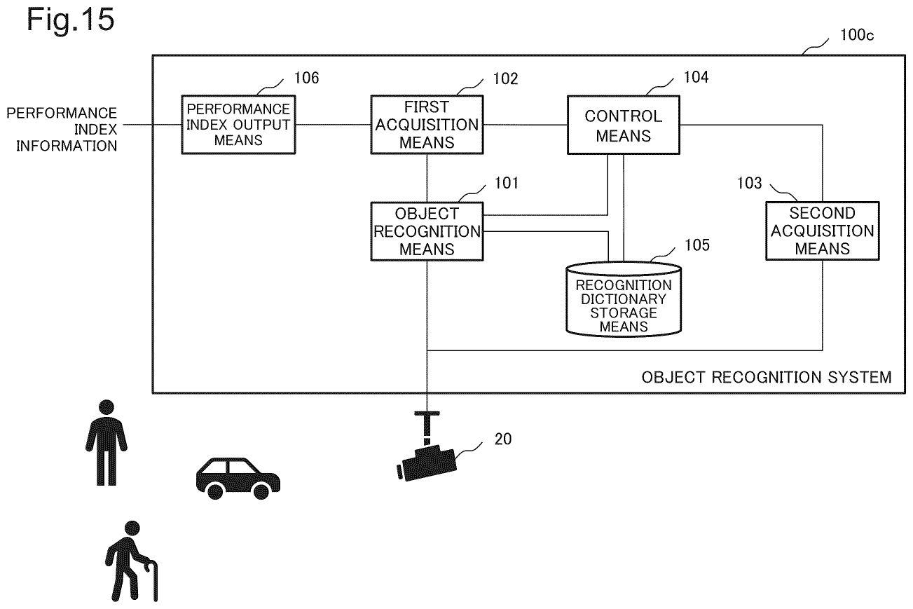

Next, the fourth example embodiment in which an output function of an index value representing the recognition performance is added to the object recognition system will be described. FIG. 15 is a functional block diagram illustrating the configuration of an object recognition system 100c of the fourth example embodiment of the present invention. A difference from the first example embodiment illustrated in FIG. 3 is that a performance index output means 106 is added. Other configurations are the same as those of the first example embodiment, and thus description thereof is omitted.

The performance index output means 106 performs an operation of acquiring the CV for each type of the moving object at a predetermined cycle and outputting the CV as a performance index of the object recognition system 100c to a predetermined output destination.

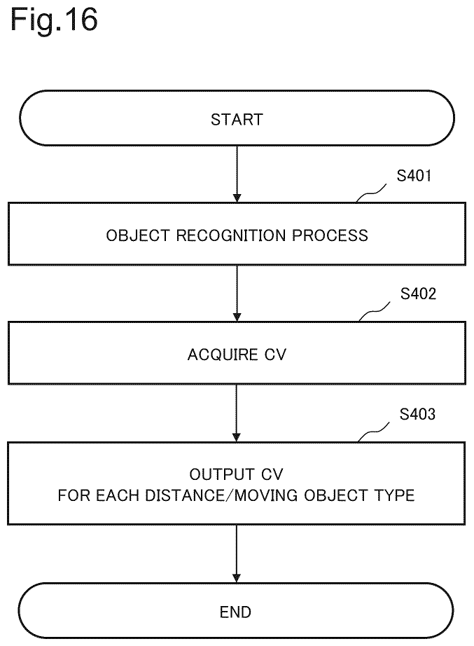

FIG. 16 is a flowchart illustrating an operation added to the object recognition system of the fourth example embodiment of the present invention. Referring to FIG. 16, first, the object recognition system 100c executes the object recognition process on the moving object appearing in the camera (step S401). This object recognition process may also serve as the normal object recognition process performed in step S101, and may be performed for outputting the performance index of the object recognition system 100c.

Next, the object recognition system 100c acquires the CV of the moving object detected by the object recognition (step S402).

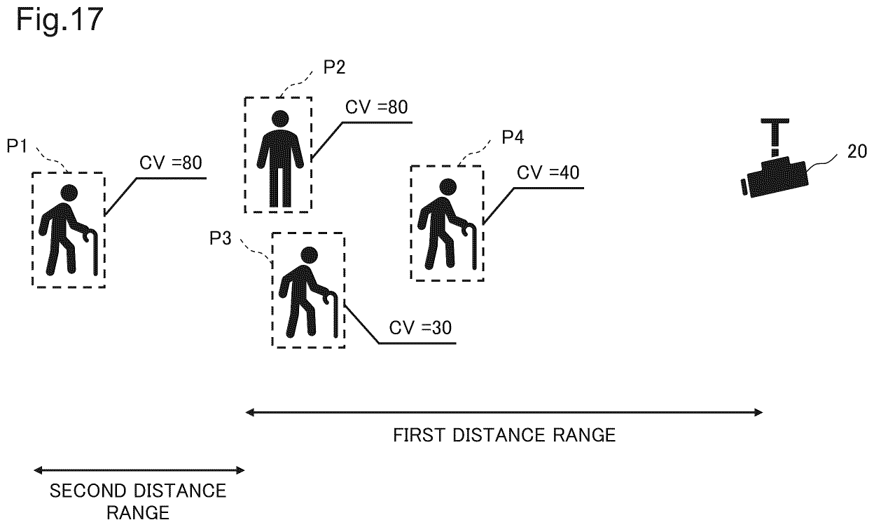

Next, the object recognition system 100c creates a screen and a form representing the acquired CV of the moving object for each moving object type and each distance to output the screen and the form to a predetermined output destination. FIG. 17 is an example of a screen created by the object recognition system 100c. In this example, the CV of the moving object is represented for each moving object type and each distance. By referring to such a screen, the user of the object recognition system 100c can visually and easily confirm that the object recognition system 100c maintains the accuracy of the moving object of which type or in which distance or conversely, that the accuracy is deteriorated.

For example, in the example of FIG. 17, it can be seen that the CVs of the elderly persons P3 and P4 among the moving objects (pedestrians) are 30 and 40, respectively, and has deteriorated. The user of such an object recognition system 100c can grasp that it is necessary to improve the CVs of the elderly persons P3 and P4 in the first distance range. For example, the user of the object recognition system 100c implements an improvement measure such as applying an existing recognition dictionary capable of improving the CVs of the elderly persons P3 and P4 in the first distance range or creating a new recognition dictionary. As a result, hereinafter, the recognition accuracy of the elderly person by the object recognition system 100c is improved.

In the example of FIG. 17, the distance range is divided into two sections of the first distance range and the second distance range, but the distance range may be subdivided more finely. For example, in a case where the main use of the object recognition system 100c is to watch the elderly person crossing a crosswalk 15 m to 20 m ahead of the camera 20, the CV may be represented by dividing the range into the section and sections before and after the section. In the example of FIG. 17, the moving object type is divided into two categories of the elderly person and the non-elderly person, but the moving object type may be subdivided more finely. This makes it easy to grasp the moving object type that the currently applied recognition dictionary is good at or poor at.

In the example of FIG. 17, it is described that the screen representing both the moving object type and the distance range is presented, but both the moving object type and the distance range may not necessarily be used. For example, a form of outputting the CV of the moving object type selected by the user or a form of outputting the CV for each distance range selected by the user can also be used. Of course, the switching may be easily performed using a drop-down list provided on the screen or a hardware key.

### (Hardware Configuration)

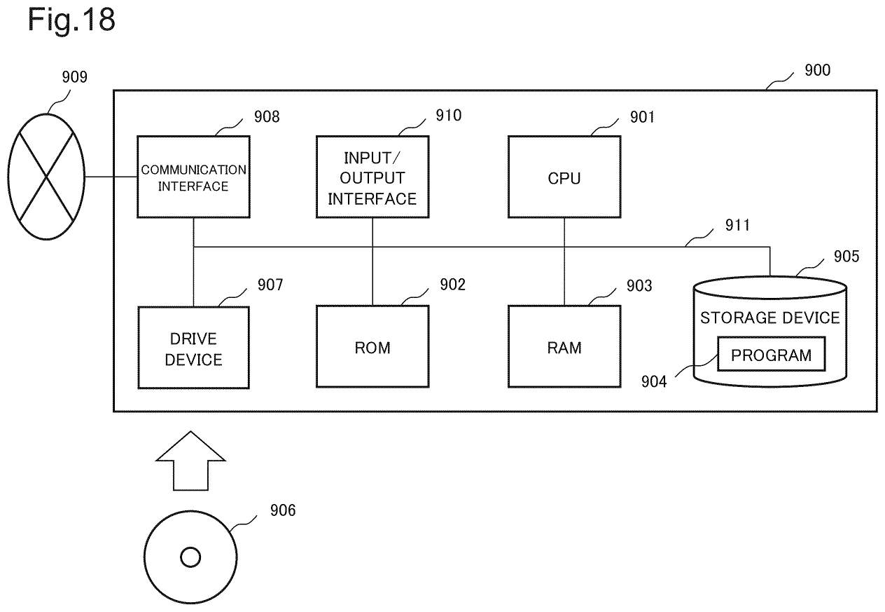

In each example embodiment of the present disclosure, each component of each device indicates a block of a functional unit. Part or all of each component of each device is achieved by, for example, any combination of an information processing device 900 and a program as illustrated in FIG. 18. FIG. 18 is a block diagram illustrating an example of a hardware configuration of the information processing device 900 that achieves each component of each device. The information processing device 900 includes the following configuration as an example.
Central processing unit (CPU) 901
Read only memory (ROM) 902
Random access memory (RAM) 903
Program 904 loaded to RAM 903
Storage device 905 storing program 904
Drive device 907 reading and writing recording medium 906
Communication interface 908 connected with communication network 909
Input/output interface 910 for inputting/outputting data
Bus 911 connecting respective components

Each component of each device in respective example embodiments is achieved by the CPU 901 acquiring and executing the program 904 for achieving these functions. That is, the CPU 901 of FIG. 18 may execute a program for detecting an object and acquiring a CV (first index value) thereof and a program for determining whether it is required to change the recognition dictionary by the CV, and may perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

The program 904 can display the processing result including the intermediate state for each stage via the display device as necessary, or can communicate with the outside via the communication interface. The program 904 can be recorded on a computer-readable (non-transitory) storage medium.

There are various modifications of the implementation method of each device. For example, each device may be achieved by any combination of the information processing device 900 and the program separate for each component. A plurality of components included in each device may be achieved by any combination of one information processing device 900 and a program. That is, the present invention can be achieved by a computer program that causes a processor mounted in each of the devices described in the first to fourth example embodiments to execute each of the above-described processes using the hardware.

Part or all of each component of each device is achieved by another general-purpose or dedicated circuit, processor, or the like, or a combination thereof. These may be configured by a single chip or may be configured by a plurality of chips connected via a bus.

Part or all of each component of each device may be achieved by a combination of the above-described circuit or the like and the program.

In a case where part or all of each component of each device is achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each of the information processing device, the circuit, and the like is connected via a communication network, such as a client and server system, a cloud computing system, and the like.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various modifications are made.

For example, in each of the example embodiments described above, it is described that the recognition dictionary is changed, but a form in which the identifier is changed from among a plurality of identifiers can also be used.

For example, in each of the above-described example embodiments, it is described that whether it is required to change the recognition dictionary is determined based on the first index value, but the control means 104, 104a may determine whether it is required to change the recognition dictionary with reference to another piece of information in addition to the first index value. For example, the control means 104, 104a may use the second index value in addition to the first index value in determining whether it is required to change the recognition dictionary. In this case, the control means 104, 104a may determine to change the recognition dictionary when the CV is equal to or less than the threshold value and the second index value indicates that the periphery of the camera 20 is dark. As the second index value, in addition to the illuminance, aperture information of the diaphragm of the camera 20, a shutter speed, an ISO value, and the like can be simply used.

Some or all of the above example embodiments may be described as the following Supplementary Notes, but are not limited to the following.

### [Supplementary Note 1]

An object recognition system including
an object recognition means for executing object recognition of a moving object appearing in a camera using a recognition dictionary,
a first acquisition means for acquiring a first index value indicating reliability of a result of object recognition of the moving object,
a second acquisition means for acquiring a second index value representing an imaging environment of the camera, and
a control means for determining whether it is required to change a recognition dictionary to be used for the object recognition based on the first index value, wherein
the control means selects the recognition dictionary to be used for the object recognition from among a plurality of recognition dictionaries based on the second index value when it is determined that the recognition dictionary is to be changed.

### [Supplementary Note 2]

The control means of the object recognition system described above may have a configuration of determining whether it is required to change the recognition dictionary to be used for the object recognition based on the first index value of one or more moving objects located in a predetermined distance range from the camera among moving objects appearing in the camera.

### [Supplementary Note 3]

The control means of the object recognition system described above may have a configuration of determining whether it is required to change the recognition dictionary based on a value obtained by weighting the first index value according to a type of the moving object.

### [Supplementary Note 4]

The control means of the object recognition system described above may have a configuration of determining whether it is required to change the recognition dictionary based on the first index value and a criterion defined for each type of the moving object.

### [Supplementary Note 5]

The control means of the object recognition system described above may have a configuration of checking whether the first index value is improved in a case of switching to a recognition dictionary selected based on the second index value, and changes the recognition dictionary in a case where the first index value is improved.

### [Supplementary Note 6]

The second index value acquired by the object recognition system described above may include at least weather information and information indicating a time zone, and
the control means may have a configuration of selecting the recognition dictionary related to a combination of the weather and the time zone from among a plurality of recognition dictionaries.

### [Supplementary Note 7]

The object recognition system described above may have a configuration of further including
a performance index output means for acquiring the first index value for each type of the moving object, and outputting the acquired first index value as a performance index of the object recognition system to a predetermined output destination.

### [Supplementary Note 8]

An object recognition method including
executing object recognition of a moving object appearing in a camera using a recognition dictionary,
acquiring a first index value indicating reliability of a result of object recognition of the moving object,
determining whether it is required to change a recognition dictionary to be used for the object recognition based on the first index value, and
when it is determined that the recognition dictionary is to be changed, acquiring a second index value representing an imaging environment of the camera, and selecting the recognition dictionary to be used for the object recognition from among a plurality of recognition dictionaries based on the second index value.

[Supplementary Note 9]

A recording medium recording a program for causing a computer to execute the steps of
executing object recognition of a moving object appearing in a camera using a recognition dictionary,
acquiring a first index value indicating reliability of a result of object recognition of the moving object,
determining whether it is required to change a recognition dictionary to be used for the object recognition based on the first index value, and
when it is determined that the recognition dictionary is to be changed, acquiring a second index value representing an imaging environment of the camera, and selecting the recognition dictionary to be used for the object recognition from among a plurality of recognition dictionaries based on the second index value.

The forms of the Supplementary Notes 8 to 9 can be expanded to the forms of the Supplementary Notes 2 to 7, as in the Supplementary Note 1.

The disclosure of the above PTL is incorporated herein by reference, and can be used as a basis or part of the present invention as necessary. Within the frame of the entire disclosure (including the claims) of the present invention, it is possible to change and adjust the example embodiments or examples further based on of the basic technical idea thereof. Various combinations or selections (including partial deletions) of various disclosure elements (respective elements of each claim, respective elements of each example embodiment or example, respective elements of each drawing, and the like are included) can be made within the frame of the disclosure of the present invention. That is, it goes without saying that the present invention includes various modifications and corrections that can be made by those of ordinary skill in the art in accordance with the entire disclosure including the claims and the technical idea. Specifically, for numerical ranges set forth herein, any numerical value or sub-range included within the range should be construed as being specifically described, even when not stated otherwise. Furthermore, it is also deemed that in the matters disclosed in the document cited above, using part or all of the matters disclosed in the document in combination with the matters described in the present specification as part of the disclosure of the present invention according to the gist of the present invention as necessary is included in the matters disclosed in the present application.

### REFERENCE SIGNS LIST

10, 100, 100a, 100b, 100c object recognition system
11, 101 object recognition means
12, 102 first acquisition means
13, 103 second acquisition means
14, 104, 104b control means
15-1 to 15-2 recognition dictionary
20 camera
105 recognition dictionary storage means
106 performance index output means
1051, 1052, 105m, 105n recognition dictionary
P1, P2 person
P3, P4 person (elderly person)
MO1 to MO4 moving object
900 information processing device
901 central processing unit (CPU)
902 read only memory (ROM)
903 random access memory (RAM)
904 program
905 storage device
906 recording medium
907 drive device
908 communication interface
909 communication network
910 input/output interface
911 bus

What is claimed is:

1. An object recognition system comprising:
at least one memory storing instructions; and
at least one processor configured to execute the instructions to:
execute object recognition of a moving object appearing in a camera using a recognition dictionary;
acquire a first index value indicating reliability of a result of object recognition of the moving object;
acquire a second index value representing an imaging environment of the camera; and
determine whether it is required to change a recognition dictionary to be used for the object recognition based on the first index value; and
select the recognition dictionary to be used for the object recognition from among a plurality of recognition dictionaries based on the second index value when it is determined that the recognition dictionary is to be changed.

2. The object recognition system according to claim 1,
wherein the at least one processor is further configured to execute the instructions to:
determine whether it is required to change the recognition dictionary to be used for the object recognition based on the first index value of one or more moving objects located in a predetermined distance range from the camera among moving objects appearing in the camera.

3. The object recognition system according to claim 1,
wherein the at least one processor is further configured to execute the instructions to:
determine whether it is required to change the recognition dictionary based on a value obtained by weighting the first index value according to a type of the moving object.

4. The object recognition system according to claim 1,
wherein the at least one processor is further configured to execute the instructions to:
determine whether it is required to change the recognition dictionary based on the first index value and a criterion defined for each type of the moving object.

5. The object recognition system according to claim 1,
wherein the at least one processor is further configured to execute the instructions to:
check whether the first index value is improved in a case of switching to a recognition dictionary selected based on the second index value, and changes the recognition dictionary in a case where the first index value is improved.

6. The object recognition system according to claim 4, wherein
the second index value includes at least weather information and information indicating a time zone, and
wherein the at least one processor is further configured to execute the instructions to:
select the recognition dictionary related to a combination of the weather and the time zone from among a plurality of recognition dictionaries.

7. The object recognition system according to claim 1,
wherein the at least one processor is further configured to execute the instructions to:
acquire the first index value for each type of the moving object, and outputting the acquired first index value as a performance index of the object recognition system to a predetermined output destination.

8. An object recognition method comprising:
executing object recognition of a moving object appearing in a camera using a recognition dictionary;
acquiring a first index value indicating reliability of a result of object recognition of the moving object;
determining whether it is required to change a recognition dictionary to be used for the object recognition based on the first index value; and
when it is determined that the recognition dictionary is to be changed, acquiring a second index value representing an imaging environment of the camera, and selecting the recognition dictionary to be used for the object recognition from among a plurality of recognition dictionaries based on the second index value.

9. A non-transitorily recording medium recording a program for causing a computer to execute the steps of:
executing object recognition of a moving object appearing in a camera using a recognition dictionary;
acquiring a first index value indicating reliability of a result of object recognition of the moving object;
determining whether it is required to change a recognition dictionary to be used for the object recognition based on the first index value; and
when it is determined that the recognition dictionary is to be changed, acquiring a second index value representing an imaging environment of the camera, and selecting the recognition dictionary to be used for the object recognition from among a plurality of recognition dictionaries based on the second index value.
